(19) United States
(12) Patent Application Publication
(10) Pub. No.: US 2026/0023044 A1
(43) Pub. Date: Jan. 22, 2026

(54) GAS SENSOR ELEMENT AND GAS SENSOR

(71) Applicant: DENSO CORPORATION, Kariya-city (JP)

(72) Inventors: Yasuhiro TAKAMURA, Kariya-city (JP); Takashi HIRAYAMA, Kariya-city (JP)

(21) Appl. No.: 19/337,151

(22) Filed: Sep. 23, 2025

Related U.S. Application Data
(63) Continuation of application No. PCT/JP2024/001817, filed on Jan. 23, 2024.

(30) Foreign Application Priority Data
Mar. 24, 2023 (JP) 2023-047901

(51) Int. Cl. G01N 27/407; G01N 27/409

(52) U.S. Cl. CPC G01N 27/4077; G01N 27/409

(57) ABSTRACT

A gas sensor element includes: a solid-state electrolyte having oxygen ion conductivity; a chamber formed on a first surface of the solid-state electrolyte, into which a gas to be measured is introduced; a chamber forming layer that is laminated on the first surface side of the solid-state electrolyte; a duct formed on a second surface of the solid-state electrolyte, into which a reference gas is introduced; and a duct forming layer that is laminated on the second surface side of the solid-state electrolyte. At least a distal end portion of the gas sensor element located distally from a proximal end of the chamber is covered with a porous protective layer. A condition of d/L≥1 is met with L denoting a thickness of the protective layer at a lamination-direction position same as that of the solid-state electrolyte and d denoting a thickness of the solid-state electrolyte.

### CROSS-REFERENCE TO RELATED APPLICATION

This application is a continuation application of International Application No. PCT/JP2024/001817 filed Jan. 23, 2024 which designated the U.S. and claims priority to Japanese Patent Application No. 2023-047901 filed Mar. 24, 2023, the contents of each of which are incorporated herein by reference.

### BACKGROUND

### Technical Field

The present disclosure relates to a gas sensor element and a gas sensor.

### Related Art

As a gas sensor element for detecting a specific gas concentration in a gas to be measured, there is a multilayer gas sensor element formed by laminating a plurality of ceramic layers including a solid-state electrolyte. For example, a multilayer gas sensor element is known in which a distal end portion of the element is covered with a porous protective layer. Providing such a protective layer is intended to trap contaminants in the gas to be measured and improve water resistance.

### BRIEF DESCRIPTION OF THE DRAWINGS

In the accompanying drawings:

FIG. 1 is a cross sectional view taken along a direction orthogonal to the X-direction of a gas sensor element according to a first embodiment, which is a cross sectional view taken along line I-I in FIG. 2;

FIG. 2 is a cross sectional view taken along a direction orthogonal to the Y-direction of the gas sensor element according to the first embodiment, which is a cross sectional view taken along line II-II in FIG. 1;

FIG. 3 is a cross sectional view taken along line III-III in FIG. 1;

FIG. 4 is a perspective view of a distal end portion of a body of the gas sensor element according to the first embodiment;

FIG. 5 is a cross sectional view taken along line V-V in FIG. 2;

FIG. 6 is a cross sectional view taken along a direction orthogonal to the X-direction of a gas sensor element having a large thickness L;

FIG. 7 is a perspective view of a distal end portion of a body of a gas sensor element according to a second embodiment;

FIG. 8 is a cross sectional view taken along a direction orthogonal to the Y-direction of the gas sensor element according to the second embodiment;

FIG. 9 is a cross sectional view taken along a direction orthogonal to the Z-direction of a chamber forming layer according to the second embodiment;

FIG. 10 is a cross sectional view taken along a direction orthogonal to the X-direction of a gas sensor element according to a third embodiment;

FIG. 11 is a cross sectional view taken along a direction orthogonal to the Y-direction of the gas sensor element according to the third embodiment;

FIG. 12 is a diagram illustrating a test result in a first experimental example;

FIG. 13 is a partial cross sectional view of a gas sensor taken along a direction orthogonal to the Z-direction according to a fourth embodiment;

FIG. 14 is an illustration of a first sample in a second experimental example;

FIG. 15 is an illustration of a third sample in the second experimental example;

FIG. 16 is a diagram illustrating a test result in the second experimental example;

FIG. 17 is a cross sectional view taken along a direction orthogonal to the X-direction of a gas sensor element according to a first modification;

FIG. 18 is a cross sectional view taken along a direction orthogonal to the X-direction of a gas sensor element according to a second modification; and

FIG. 19 is a cross sectional view taken along a direction orthogonal to the X-direction of a gas sensor element according to a third modification.

### DESCRIPTION OF SPECIFIC EMBODIMENTS

In a multilayer gas sensor element including a protective layer, as disclosed in JP 2009-80100 A, there is an issue in that measurement errors may occur. That is, such an element has the problem that it is difficult to stably secure high measurement accuracy.

In view of the foregoing, it is desired to have a gas sensor element and a gas sensor capable of improving the measurement accuracy.

One aspect of the present disclosure provides a gas sensor element including: a solid-state electrolyte having oxygen ion conductivity; a chamber formed on a first surface of the solid-state electrolyte, into which a gas to be measured is introduced; a chamber forming layer that is laminated on the first surface side of the solid-state electrolyte to form the chamber; a duct formed on a second surface of the solid-state electrolyte, into which a reference gas is introduced; and a duct forming layer that is laminated on the second surface side of the solid-state electrolyte to form the duct. At least a distal end portion of the gas sensor element located distally from a proximal end of the chamber is covered with a porous protective layer. A condition of d/L≥1 is met with L denoting a thickness of the protective layer at a lamination-direction position same as that of the solid-state electrolyte and d denoting a thickness of the solid-state electrolyte.

Another aspect of the present disclosure provides a gas sensor including: the gas sensor element; a housing that holds the gas sensor element; and an element cover attached to a distal end side of the housing and surrounding the gas sensor element from the distal end side. The element cover has a vent hole disposed to face the chamber in the gas sensor element.

In the above gas sensor element, the thickness L of the protective layer at the same lamination-direction position as the solid-state electrolyte and the thickness d of the solid-state electrolyte meet the condition d/L≥1. This can improve the measurement accuracy of the gas sensor element.

The gas sensor incorporates the gas sensor element meeting d/L≥1. Accordingly, a gas sensor with high measurement accuracy can be provided. Further, the element cover has a vent hole disposed to face the chamber in the gas sensor element. This can improve the measurement accuracy.

As described above, according to the above aspects, it is possible to provide a gas sensor element and a gas sensor capable of improving the measurement accuracy.

### First Embodiment

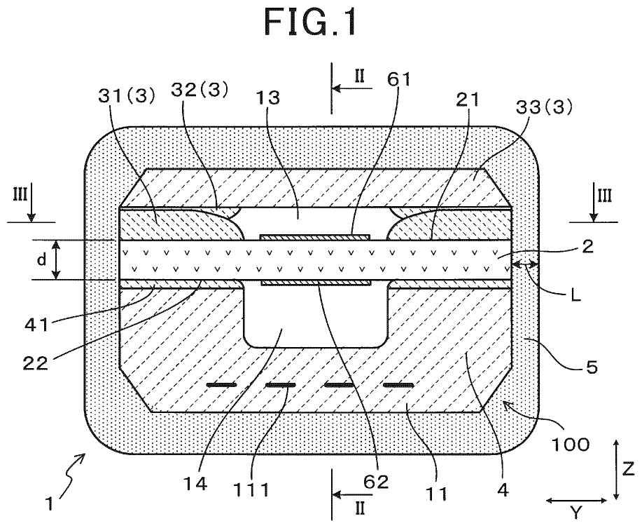

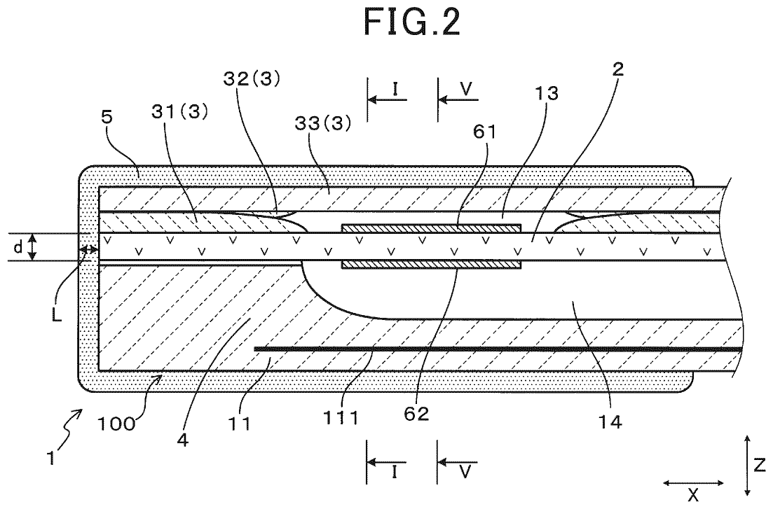

A gas sensor element and a gas sensor according to one embodiment will now be described with reference to FIGS. 1 to 5. In the present embodiment, the gas sensor element 1 includes a solid-state electrolyte 2, a chamber 13, a chamber forming layer 3, a duct 14, and a duct forming layer 4, as illustrated in FIGS. 1 and 2.

The solid-state electrolyte 2 has oxygen ion conductivity. The chamber 13 faces a first surface 21 of the solid-state electrolyte 2 and defines a space into which a gas to be measured is introduced. The chamber forming layer 3 is laminated on the first surface 21 side of the solid-state electrolyte 2 to form the chamber 13. The duct 14 faces a second surface 22 of the solid-state electrolyte 2 and defines a space into which a reference gas is introduced. The duct forming layer 4 is laminated on the second surface 22 side of the solid-state electrolyte 2 to form the duct 14.

At least a distal end portion of the element, located distally from the proximal end of the chamber 1, is covered with a porous protective layer 5. The gas sensor element 1 of the present embodiment meets the condition d/L≥1, where L is the thickness of the protective layer 5 at the same lamination-direction position as the solid-state electrolyte 2, and d is the thickness of the solid-state electrolyte 2.

The gas sensor element 1 of the present embodiment is a multilayer gas sensor element in which a plurality of ceramic layers are laminated. In the gas sensor element 1, a sensor electrode 61 and a reference gas side electrode 62 are formed respectively on one surface (i.e., a first surface 21) and the other surface (i.e., a second surface 22) of the plate-like solid-state electrolyte 2. The sensor electrode 61 and the reference gas side electrode 62 are disposed to face each other with a portion of the solid-state electrolyte 2 interposed therebetween. A sensor cell is formed by the sensor electrode 61, the reference gas side electrode 62, and the portion of the solid-state electrolyte 2 located between the sensor electrode 61 and the reference gas side electrode 62. The sensor electrode 61 is responsive to a specific gas contained in the gas to be measured. For example, the gas to be measured is exhaust gas from an internal combustion engine, and the specific gas is oxygen. The sensor electrode 61 that is responsive to oxygen contains, for example, platinum (Pt) and gold (Au) or rhodium (Rh).

As described above, the gas sensor element 1 is formed by laminating the chamber forming layer 3 on the first surface 21 of the solid-state electrolyte 2. The chamber forming layer 3 includes buffer layers 31 and 32 and a shielding layer 33, which are sequentially laminated on the first surface 21 of the solid-state electrolyte 2. The duct forming layer 4 is laminated on the second surface 22 of the solid-state electrolyte 2 via a buffer layer 41. The buffer layer 41 is also a portion of the duct forming layer 4 that forms the duct 14, but in the present embodiment, the portion excluding the buffer layer 41 may also be referred to as the duct forming layer 4. Further, a heater layer 11 is laminated on a surface of the duct forming layer 4 opposite from the solid-state electrolyte 2. A heater wiring 111 is formed between the heater layer 11 and the duct forming layer 4. Further, the heater layer 11 and the duct forming layer 4 may be integrated such that no particular boundary exists between them.

In this specification, the lamination direction in which the plurality of ceramic layers are laminated is referred to, as appropriate, as the Z direction. The gas sensor element 1 has an elongated flat rod shape in one direction orthogonal to the Z direction. The longitudinal direction of the gas sensor element 1 is referred to, as appropriate, as the X direction. The direction orthogonal to both the X direction and the Z direction is referred to, as appropriate, as the Y direction.

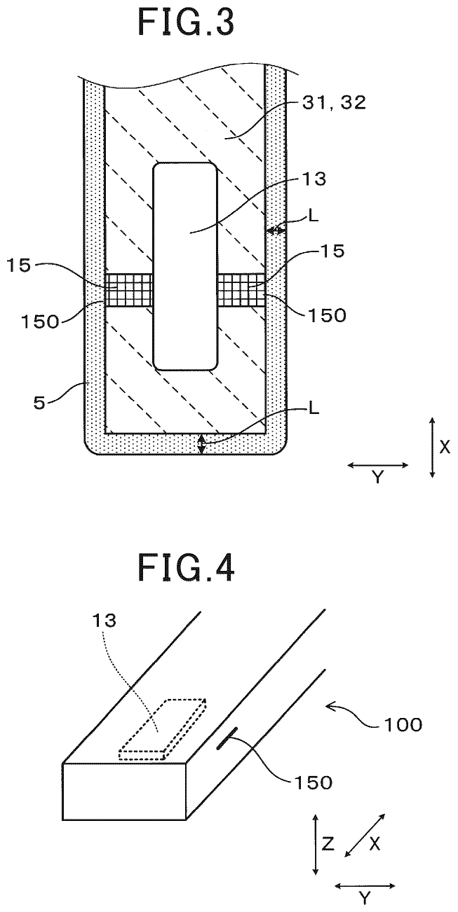

Further, as illustrated in FIG. 3, as viewed from the Z direction, the chamber 13 is surrounded by the buffer layers 31 and 32, but a porous diffusion layer 15 is disposed at portions of the outer periphery of the chamber 13. In the present embodiment, the diffusion layer 15 is disposed on both sides of the chamber 13 in the Y direction. Accordingly, the gas to be measured is configured to be introduced into the chamber 13 via the diffusion layer 15 from both sides in the Y direction. That is, as illustrated in FIGS. 3, 4, and 5, inlets 150 for the gas to be measured into the chamber 13 are provided on both Y-directional opposite sides of a main body 100 of the gas sensor element 1. Here, the main body 100 refers to the gas sensor element 1 in a state where the protective layer 5 is not formed, and FIG. 4 illustrates a perspective view of a distal end portion of the main body 100. In the present embodiment, the chamber 13 has a shape longer in the X direction than in the Y direction.

In the present embodiment, the solid-state electrolyte 2 is a ceramic layer mainly composed of zirconia. The shielding layer 33, the duct forming layer 4, and the heater layer 11 are each a ceramic layer mainly composed of alumina. The diffusion layer 15 is also mainly composed of alumina. However, the diffusion layer 15 is composed of a porous ceramic body to allow the gas to be measured to pass through. On the other hand, the solid-state electrolyte 2, the shielding layer 33, the duct forming layer 4, the heater layer 11, and the buffer layers 31, 32, and 41 are made of dense ceramic bodies that do not allow the gas to be measured to pass through.

The buffer layers 31 and 32 are made of a material having a coefficient of linear expansion between that of the solid-state electrolyte 2 and the shielding layer 33. The buffer layer 41 is made of a material having a coefficient of linear expansion between that of the solid-state electrolyte 2 and the duct forming layer 4. For example, the buffer layers 31, 32, and 41 contain alumina and zirconia.

The protective layer 5 is made of porous ceramic. In the present embodiment, the porous ceramic forming the protective layer 5 is composed of alumina. As illustrated in FIGS. 1 and 2, the protective layer 5 is formed so as to cover the entire periphery and the distal end surface of the element distal end portion. As described above, the condition d/L≥1 is met, where L is the thickness of the protective layer 5 at the same lamination-direction position as the solid-state electrolyte 2 and d is the thickness of the solid-state electrolyte 2. That is, the thickness L of the protective layer 5 is equal to or less than the thickness d of the solid-state electrolyte 2.

In the present embodiment, the thickness L of each of portions of the protective layer 5 covering Y-directional sides of the gas sensor element 1 is substantially constant, which thickness is equal to or less than the thickness d of the solid-state electrolyte 2. Further, the thickness L of the portion covering the distal end surface of the gas sensor element 1 is also substantially constant, which thickness is equal to or less than the thickness d of the solid-state electrolyte 2. It should be noted that both the thickness L of the protective layer 5 on each Y-directional side of the gas sensor element 1 and the thickness L of the protective layer 5 on the distal end surface of the gas sensor element meet the condition d/L≥1.

In the present embodiment, as described above, the inlets 150 for the gas to be measured are provided on both the Y-directional sides. Therefore, considering an inflow route in which the reference gas leaking from the duct 14 flows into the chamber 13 through the diffusion layer 15 via each inlet 150, it is considered more important to reduce the thickness L of the protective layer 5 on each Y-directional side of the gas sensor element 1. Accordingly, the thickness L of the protective layer 5 on each Y-directional side of the gas sensor element 1 may also be made less than the thickness L of the protective layer 5 on the distal end surface of the gas sensor element.

The thickness L of the protective layer 5 may, for example, range from 10 to 400 μm. The porosity of the protective layer 5 may, for example, range from 20 to 70%.

Next, an outline will be given of an example of a method for manufacturing the gas sensor element 1 of the present embodiment. First, a ceramic green sheet for the solid-state electrolyte 2, a ceramic green sheet for the shielding layer 33, a ceramic green sheet for the duct forming layer 4, a ceramic green sheet for the heater layer 11, and a ceramic green sheet for the diffusion layer 15 are prepared. The diffusion layer 15 may be formed not from a ceramic green sheet but by printing a ceramic paste.

The ceramic green sheet for the duct forming layer 4 and the ceramic green sheet for the heater layer 11 are laminated together in advance. Before this lamination, a conductive paste for heater wiring is printed on the heater layer 11. Further, the duct forming layer 4 may also be formed by laminating a plurality of ceramic green sheets. A laminate obtained by laminating and integrating the ceramic green sheet for the duct forming layer 4 and the ceramic green sheet for the heater layer 11 is hereinafter appropriately referred to as a duct-side laminated sheet.

Using a conductive paste, the sensor electrode 61 and the reference gas side electrode 62 are formed on the first surface 21 and the second surface 22 of the ceramic green sheet for the solid-state electrolyte 2, respectively. Further, a ceramic paste for the buffer layer 31 is applied to a predefined position on the first surface 21 of the ceramic green sheet for the solid-state electrolyte 2.

Further, a ceramic green sheet for the diffusion layer 15 is disposed (or alternatively, a ceramic paste for the diffusion layer 15 is printed) at a predefined position on a surface of the ceramic green sheet for the shielding layer 33, which faces the solid-state electrolyte 2, and a ceramic paste for the buffer layer 32 is applied. The ceramic green sheet for the shielding layer 33, on which the ceramic paste has been applied, is laminated and pressed onto the first surface 21 of the ceramic green sheet for the solid-state electrolyte 2.

Further, a ceramic paste for the buffer layer 41 is applied to a predefined position on a surface of the duct-side laminated sheet, which faces the solid-state electrolyte 2. The duct-side laminated sheet, on which the ceramic paste has been applied, is laminated and pressed onto the second surface 22 of the ceramic green sheet for the solid-state electrolyte 2. Baking the laminated body in this state results in the formation of the main body 100 of the gas sensor element 1.

Next, the distal end portion of the main body 100 of the gas sensor element 1 is immersed in a ceramic slurry for forming the protective layer 5. As a result, the ceramic slurry adheres to the distal end portion of the gas sensor element 1. Drying and baking this adhered ceramic slurry leads to formation of the protective layer 5.

The thickness L of the protective layer 5 can be controlled, for example, by adjusting the viscosity and surface tension of the above-described ceramic slurry, the average particle size of ceramic powder, and the like.

The gas sensor element 1 of the present embodiment is incorporated, for example, in a gas sensor installed in an exhaust system of an internal combustion engine. Exhaust gas as the gas to be measured is introduced into the chamber 13, and atmospheric air as the reference gas is introduced into the duct 14. Applying a predefined voltage to the sensor cell causes a specific current to flow according to a difference in oxygen concentration between the duct 14 and the chamber 13. Within a certain applied voltage range, even if the applied voltage changes, little change occurs in the output current value. This current is referred to as a limit current. Based on this limit current, the oxygen concentration in the exhaust gas can be detected. Thus, the gas sensor element 1 of the present embodiment can be used as an element of a so called limit-current type air-fuel ratio sensor.

The protective layer 5 has, for example, a function of trapping poisoning substances contained in the exhaust gas. This can prevent poisoning substances from entering the chamber 13. Further, the protective layer 5 also has a function of suppressing water-induced cracking. At the time of starting the internal combustion engine or the like, water present in the exhaust pipe may fly toward the gas sensor element 1 together with the exhaust gas. In such a case, the presence of the protective layer 5 makes it possible to prevent water from directly adhering to the main body 100 of the element. This can inhibit element cracking (i.e., water-induced cracking) caused by stress generated due to adhesion of water.

The functions and effects of the present embodiment will now be described. In the gas sensor element 1 described above, the thickness L of the protective layer 5 at the same lamination-direction position as the solid-state electrolyte 2 and the thickness d of the solid-state electrolyte 2 meet the condition d/L≥1. This can improve the measurement accuracy of the gas sensor element 1. The mechanism thereof will be described below. In the following description, the gas to be measured is exhaust gas, the reference gas is atmospheric air, and the specific gas is oxygen.

As described above, the solid-state electrolyte 2 and the duct forming layer 4 are in close contact with each other. However, due to differences in materials between the two, it is difficult to achieve complete hermetic sealing. Therefore, a minute gap may partially occur between the solid-state electrolyte 2 and the duct forming layer 4. When oxygen leaks from the duct 14 through such a gap, the leak oxygen first reaches the protective layer 5.

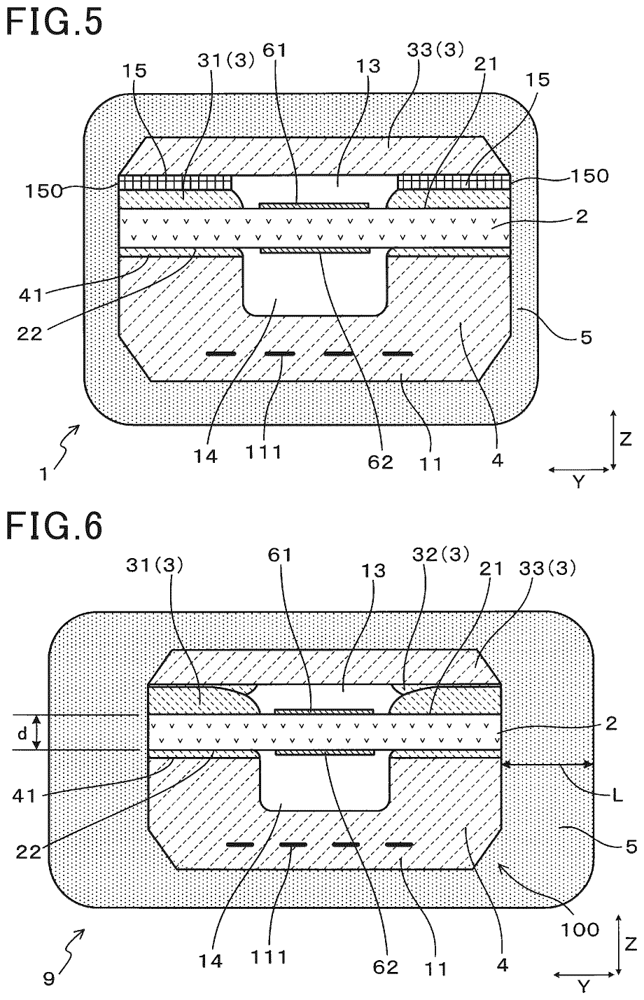

For example, as in the gas sensor element 9 illustrated in FIG. 6, when the thickness L of the protective layer 5 is large, oxygen tends to remain within the protective layer 5. Then, a portion of the oxygen retained in protective layer 5 may diffuse within the protective layer 5 and enter the chamber 13. That is, due to differences in materials, it is also difficult to achieve complete hermetic sealing between the solid-state electrolyte 2 and the chamber forming layer 3 (i.e., the buffer layers 31 and 32 and the shielding layer 33). Therefore, similarly, oxygen intrusion from the protective layer 5 into the chamber 13 is hardly avoidable. Further, when a portion of the oxygen reaches any of the inlets 150 via the protective layer 5, a portion of the oxygen may also enter the chamber 13 via the diffusion layer 15.

In this manner, when oxygen enters the chamber 13, the oxygen concentration in the exhaust gas within the chamber 13 varies. That is, the oxygen concentration in the exhaust gas to be measured varies within the chamber 13, thereby causing measurement errors.

For example, when the internal combustion engine undergoes stoichiometric combustion, the oxygen concentration in the exhaust gas becomes substantially zero, but if the above phenomenon occurs, oxygen is detected by the gas sensor. That is, in the case of stoichiometric combustion, the output current of the gas sensor should become zero. However, when the above phenomenon occurs, the oxygen concentration does not become zero, and the gas sensor undesirably outputs some current. This causes measurement errors.

Therefore, in order to inhibit the above-described phenomenon, the gas sensor element 1 of the first embodiment is configured such that the thickness L of the protective layer 5 at the same lamination-direction position as the solid-state electrolyte 2 meets d/L≥1 in relation to the thickness d of the solid-state electrolyte 2. Accordingly, even if oxygen leaks from the duct 14, the small thickness L of the protective layer 5 allows the leak oxygen to be readily released to the outside of the protective layer 5 and the leak oxygen is thus unlikely to remain within the protective layer 5. That is, a small thickness L of the protective layer 5 leads to a large oxygen concentration gradient between the outside and the inside of the protective layer 5, allowing the leak oxygen to be readily discharged to the outside of the protective layer 5. On the other hand, a large thickness L of the protective layer 5 leads to a small oxygen concentration gradient between the outside and the inside of the protective layer 5, making it difficult for oxygen to be discharged to the outside of the protective layer 5.

Further, when the thickness d of the solid-state electrolyte 2 is small, a portion of the oxygen that has leaked from the duct 14 to the protective layer 5 on the second surface 22 side readily moves toward the first surface 21 side. As a result, a portion of the oxygen that has leaked into the protective layer 5 likely enters the chamber 13. On the other hand, when the thickness d of the solid-state electrolyte 2 is large, the diffusion distance of a portion of the oxygen that has leaked from the duct 14 to the protective layer 5 on the second surface 22 side toward the first surface 21 side increases. Therefore, the oxygen that has leaked into the protective layer 5 is less likely to enter the chamber 13.

Therefore, in order to inhibit the above phenomenon, it is preferable that the thickness d is large and the thickness L is small. Accordingly, as a result of diligent research, the inventors of the present application have found that, when the condition d/L≥1 is met, the above phenomenon can be inhibited and detection errors of the gas sensor can be sufficiently reduced. Experimental results thereof will be described later.

As described above, according to the present embodiment, it is possible to provide a gas sensor element capable of improving the measurement accuracy.

### Second Embodiment

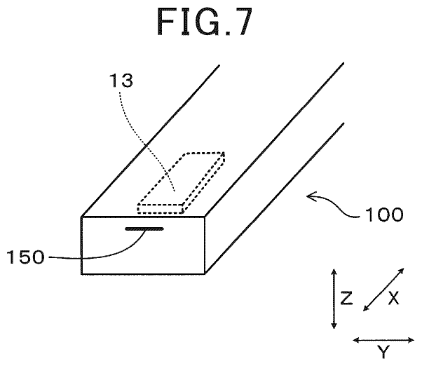

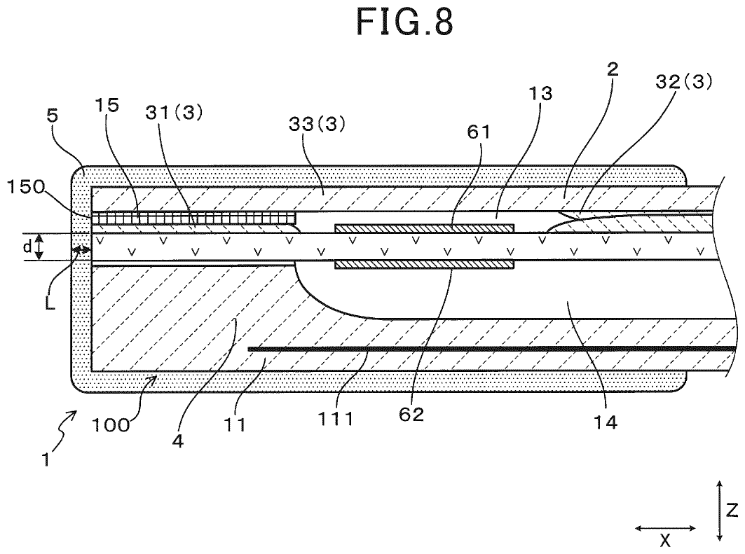

In a second embodiment, as illustrated in FIGS. 7 to 9, the gas sensor element 1 has an exhaust gas inlet 150 provided on its distal end surface. That is, in the gas sensor element 1 of the present embodiment, a diffusion layer 15 is provided on the distal end side of the chamber 13. Accordingly, the inlet 150 is arranged on the distal end surface of the gas sensor element 1.

Also in the present embodiment, the thickness L of the protective layer 5 (see FIGS. 1, 8, and 9) meets the condition d/L≥1.

In the present embodiment, as described above, the inlet 150 for exhaust gas is provided on the distal end surface. Therefore, considering an inflow route in which oxygen leaking from the duct 14 flows into the chamber 13 through the diffusion layer 15 via the inlet 150, it is considered more important to reduce the thickness L of the protective layer 5 on the distal end surface. Accordingly, the thickness L of the protective layer 5 on the distal end surface of the element may also be made less than the thickness L of the protective layer 5 on each Y-directional side of the gas sensor element 1.

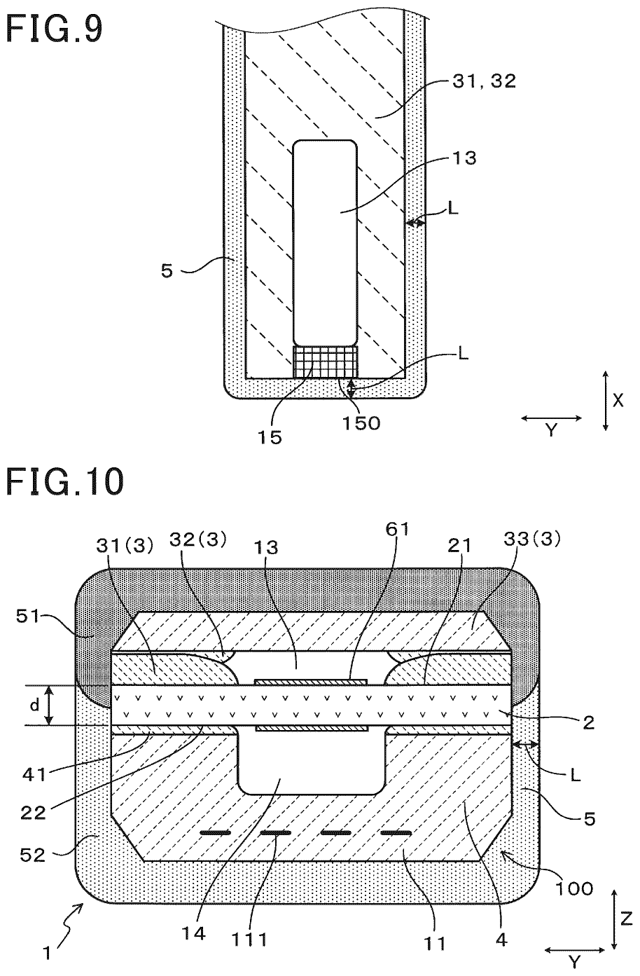

However, even on each of Y-directional sides of the gas sensor element 1 where no diffusion layer 15 is provided, oxygen intrusion into the chamber 13 may occur as described above, and therefore the thickness L of the protective layer 5 on each side (see FIGS. 1 and 9) is also set to meet d/L≥1.

Other features are the same as those in the first embodiment. In the following embodiments, reference numerals used in the figures, which are the same as those used in the first and second embodiments, denote components and the like similar to those of the first embodiment unless otherwise specified. The present embodiment also has the same functions and effects as the first embodiment.

### Third Embodiment

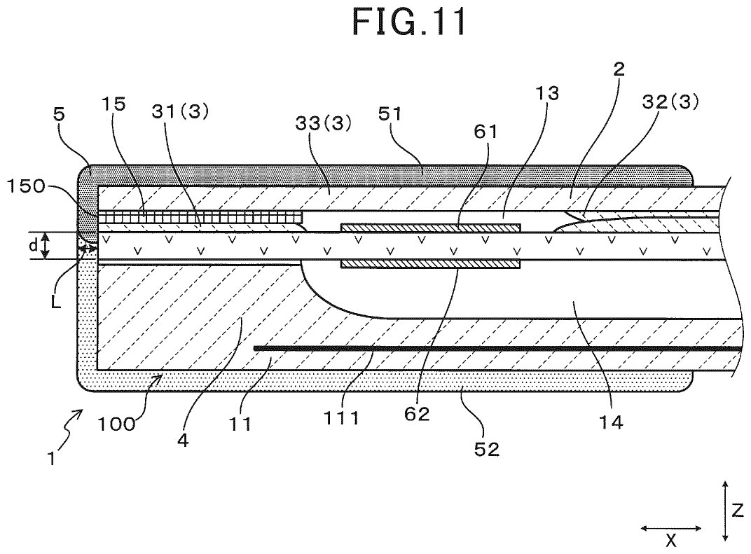

In a third embodiment, as illustrated in FIGS. 10 and 11, the protective layer 5 of the gas sensor element 1 includes a first protective layer 51 and a second protective layer 52. The first protective layer 51 is disposed to include at least a boundary between the solid-state electrolyte 2 and the chamber forming layer 3. The second protective layer 52 is disposed to include at least a boundary between the solid-state electrolyte 2 and the duct forming layer 4.

In the present embodiment, at the distal end portion of the gas sensor element, the first protective layer 51 is formed to cover a portion of the solid-state electrolyte 2 and the chamber forming layer 3 (i.e., the buffer layers 31 and 32 and the shielding layer 33). The second protective layer 52 is formed to cover a portion of the solid-state electrolyte 2, the duct forming layer 4, and the heater layer 11.

The porosity of the second protective layer 52 is higher than that of the first protective layer 51. The porosity of the first protective layer 51 ranges from 20 to 40% by volume, and the porosity of the second protective layer 52 ranges from 40 to 70% by volume.

Other features are the same as those in the first embodiment.

In the present embodiment, oxygen that has leaked from the duct 14 first reaches the second protective layer 52. Since the second protective layer 52 has a relatively high porosity, the that has leak oxygen is likely to be discharged to the outside of the protective layer 5. On the other hand, since the first protective layer 51 has a relatively low porosity, oxygen is less likely to diffuse from the second protective layer 52 into the first protective layer 51. Therefore, intrusion of oxygen that has leaked from the duct 14 into the chamber 13 can be effectively inhibited.

The porosity of the first protective layer 51 ranges from 20 to 40% by volume, and the porosity of the second protective layer 52 ranges from 40 to 70% by volume. Accordingly, the above-described effects can be more readily achieved. That is, since the porosity of the second protective layer 52 is higher than that of the first protective layer 51, and the porosity of the first protective layer 51 is 40% by volume or lower while the porosity of the second protective layer 52 is 40% by volume or higher, the above-described effects can be more readily achieved. When the porosity of the first protective layer 51 is lower than 20% by volume, sufficient introduction of the gas to be measured (exhaust gas) into the chamber 13 may be difficult to achieve. Further, when the porosity of the second protective layer 52 exceeds 70% by volume, it may be difficult to sufficiently enhance the trapping effect of poisoning substances and the suppression effect of water-induced cracking by the protective layer 5. Other functions and effects are the same as those of the first embodiment.

### First Experimental Example

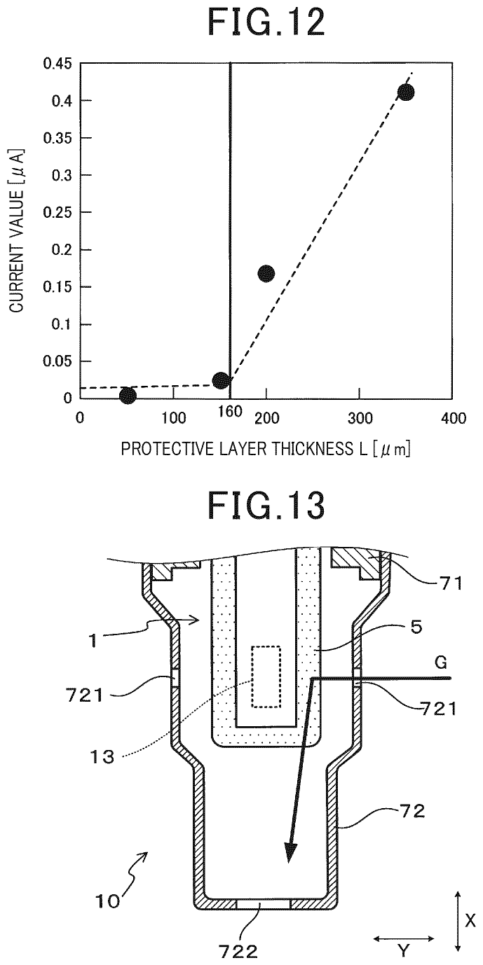

As illustrated in FIG. 12, this example is an example in which a relationship between the thickness L of the protective layer on each side of the gas sensor element and the measurement accuracy of the gas sensor element was examined.

As the gas sensor element used as a sample, one having the same basic structure as that illustrated in the second embodiment was employed. However, several types were fabricated in which the thickness L of the protective layer 5 on both sides was varied. Further, the thickness L of the protective layer 5 on the distal end surface was set to 100 μm in all the samples. The thickness d of the solid-state electrolyte 2 was set to 160 μm.

The following test was performed for each sample. First, a gas sensor including the gas sensor element was installed in a model gas bench simulating an exhaust gas flow. Nitrogen gas was supplied in the model gas bench instead of exhaust gas. That is, nitrogen gas having an oxygen concentration substantially zero, similar to stoichiometric exhaust gas, was supplied.

The gas sensor element was heated to an activation temperature by energizing a heater incorporated in the gas sensor element. In this state, the current value flowing through the sensor cell when a predefined voltage was applied thereto, i.e., a limit current value, was measured.

The results are shown in FIG. 12. As described above, in this example, since the gas to be measured is nitrogen gas corresponding to stoichiometric gas, the limit current value should ideally be zero. However, as shown in FIG. 12, there were cases in which a current was output. In samples where the thickness L of the protective layer 5 exceeded 160 μm, that is, exceeded the thickness d of the solid-state electrolyte 2, noise current was detected. It was also confirmed that the greater the thickness L, the larger the noise current became. This noise current is presumed to be caused, as described above, by a portion of the oxygen that has leaked from the duct 14 entering the chamber 13.

In contrast, in the samples where the thickness L of the protective layer 5 was less than 160 μm, that is, equal to or less than the thickness d of the solid-state electrolyte 2, almost no current was output. In particular, in the samples where the thickness L of the protective layer 5 was one half or less of the thickness d of the solid-state electrolyte 2, substantially no current was output.

From the above results, it can be understood that the thickness L of the protective layer, when d/L≥1 is met, can sufficiently reduce noise and improve the detection accuracy. It can also be understood that the thickness L of the protective layer, when d/L≥2 is met, can further reduce noise and improve the detection accuracy.

### Fourth Embodiment

As illustrated in FIG. 13, a gas sensor 10 including a gas sensor element 1 according to a fourth embodiment will now be described.

The gas sensor 10 includes the gas sensor element 1, a housing 71, and an element cover 72. The housing 71 holds the gas sensor element 1. The element cover 72 is attached to a distal end side of the housing 71 and surrounds the gas sensor element 1 from the distal end side. The element cover 72 has vent holes 721 disposed to face the chamber 13 of the gas sensor element 1.

The housing 71 directly or indirectly holds the gas sensor element 1. For example, in the present embodiment, the gas sensor element 1 is held via an insulator, which is not illustrated. Further, the vent holes 721 face the chamber 13 with the protective layer 5 and the like interposed therebetween. That is, the position of the vent holes 721 facing the chamber 13 in the gas sensor element 1 refers to a position at which the vent holes 721 overlap the chamber 13 in the X direction.

Further, in the X direction, at least a portion of each vent hole 721 overlaps at least a portion of the chamber 13. Preferably, in the X direction, the center of each vent hole 721 overlaps the chamber 13. Preferably, in the X direction, the entirety of each vent hole 721 is included within a region where the chamber 13 is formed. Preferably, in the X direction, each vent hole 721 is disposed so as to partially or entirely overlap the diffusion layer 15.

The element cover 72 also has a vent hole 722 at its distal end portion. As illustrated in FIG. 13, exhaust gas G introduced into the element cover 72 through the side vent holes 721 is discharged through the distal end vent hole 722. Meanwhile, a portion of the exhaust gas G is introduced into the chamber 13 of the gas sensor element 1.

In the present embodiment, the vent holes 721 are formed to face the gas sensor element 1 in the Y direction. The configuration of the gas sensor element 1 is the same as that in the first embodiment. Accordingly, the diffusion layers 15 are formed on both Y-directional sides of the chamber 13 (see FIGS. 3 to 5).

In the present embodiment, as illustrated in FIG. 13, exhaust gas G flowing from the vent hole 721 of the element cover 72 into the inside thereof collides with a position around the chamber 13 of the gas sensor element 1. As a result, a sufficient flow of exhaust gas G passes through the protective layer 5 around the chamber 13. Consequently, oxygen leaking from the duct 14 is likely to be discharged from the protective layer 5 along with the flow of exhaust gas G. Therefore, retention of oxygen in the protective layer 5 near the chamber 13 is inhibited, and intrusion of oxygen into the chamber 13 can be effectively inhibited. Other functions and effects are the same as those of the first embodiment.

In the gas sensor 10 of the present embodiment, the element cover 72 may have a double-layered or multi-layered structure. In this case, the vent hole provided in the innermost element cover, i.e., the element cover closest to the gas sensor element 1, serves as the vent hole 721 that meets the above-described position in the X direction.

### Second Experimental Example

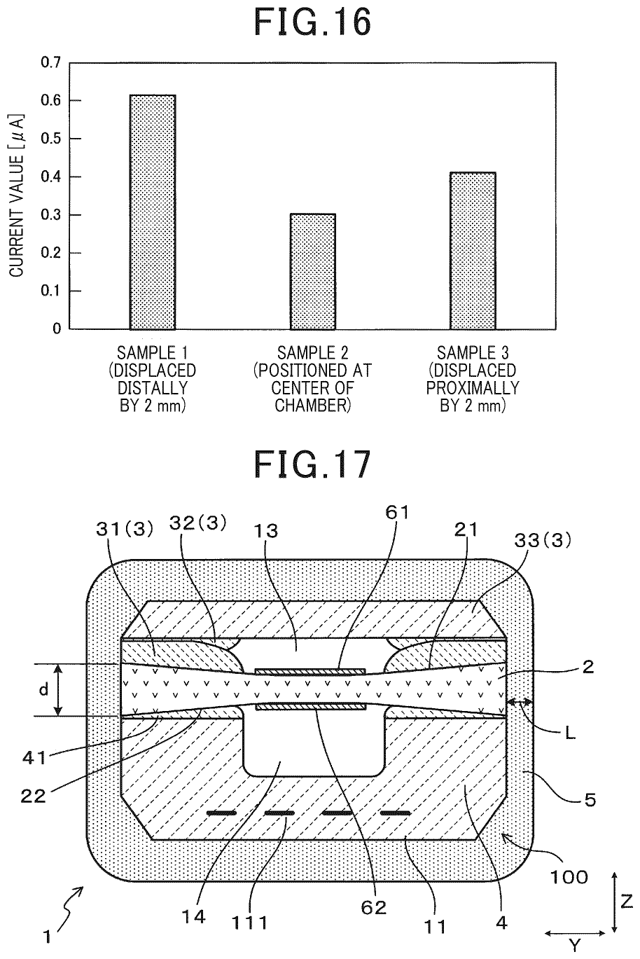

As illustrated in FIG. 16, this example is an example in which a relationship between the position of each vent hole 721 in the X direction and the measurement accuracy of the gas sensor element was examined.

As the gas sensor element used as a sample, one having the same basic structure as that illustrated in the fourth embodiment was employed. However, in all the samples, the thickness L of the protective layer 5 was 400 μm, and the condition d/L≥1 was not met. Accordingly, all the samples differ from the gas sensor element 1 according to the fourth embodiment. This is because, in order to clarify the influence of the position of each vent hole 721, the structure of the gas sensor element itself was made disadvantageous in terms of inhibiting oxygen intrusion into the chamber 13. Except for the thickness L of the protective layer, the structure of the gas sensor element was the same as that of the first embodiment.

Then, several types of samples were fabricated in which the positions of the respective vent holes 721 of the element cover 72 differ. Further, gas sensor elements having substantially the same configuration were prepared. The thickness d of the solid-state electrolyte 2 was set to 160 μm. Each vent hole 721 was circular with a diameter of 1.6 mm.

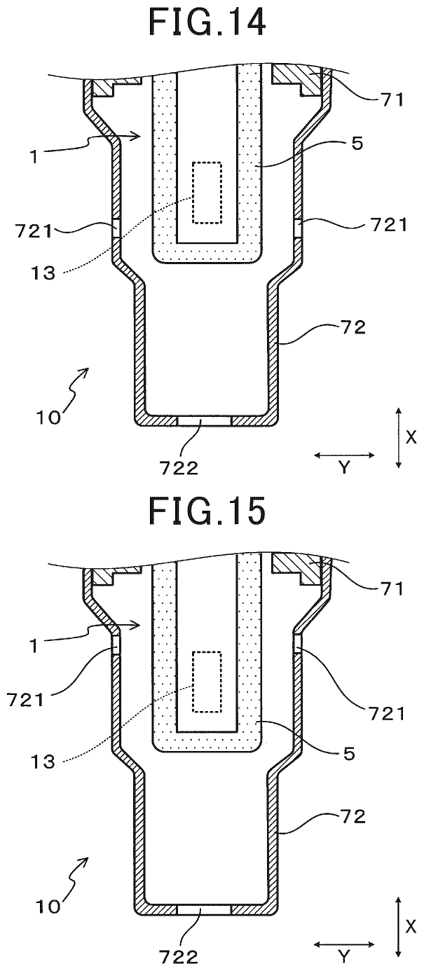

As illustrated in FIG. 14, sample 1 was fabricated in which the center position of each vent hole 721 was displaced by 2 mm toward the distal end from the center position of the chamber 13. As illustrated in FIG. 13, sample 2 was fabricated in which the center position of each vent hole 721 was set to the same X-directional position as the center of the chamber 13. As illustrated in FIG. 15, sample 3 was fabricated in which the center position of each vent hole 721 was displaced by 2 mm toward the proximal end from the center position of the chamber 13. Further, the length of the chamber 13 in the X direction was set to 3.4 mm.

For each sample, a test similar to that of the first experimental example was conducted. A gas sensor was installed in the same model gas bench as in the first experimental example, and the limit current value was measured in the same manner. The results are shown in FIG. 16.

As can be seen from the figure, noise current is suppressed in samples 2 and 3 as compared to in sample 1. This means that setting the position of each vent hole 721 to the position of the center of the chamber 13 in the X direction or a position slightly displaced toward the proximal end side from the center of the chamber 13 in the X direction is more effective in inhibiting oxygen intrusion into the chamber 13 than setting the position of each vent hole 721 to a position displaced toward the distal end side from the center of the chamber 13 in the X direction. This is consistent with the mechanism by which oxygen that has leaked into the protective layer 5 near the chamber 13 is discharged by the flow of exhaust gas G introduced from the vent holes 721. Further, since the noise current in sample 2 is particularly small, it is considered that a greater effect can be achieved by providing the vent holes 721 at the center of the chamber 13 in the X direction.

The gas sensor element and the gas sensor according to the present disclosure are not limited to those illustrated in the above embodiments, and various configurations can be conceived.

For example, as in the first modification illustrated in FIG. 17, the thickness of the solid electrolyte 2 at the Y-directional center may be different from that at the Y-directional ends. In this case, the thickness d of the solid-state electrolyte 2 is defined as the thickness at the Y-directional ends. As described above, oxygen entering the chamber 13 is oxygen that has leaked from the duct 14 into the protective layer 5. Considering the foregoing, it is apparent that the parameter relevant to inhibition of oxygen intrusion into the chamber 13 is not the thickness of the central portion of the solid electrolyte 2, but rather the thickness of the end portions of the solid electrolyte 2. Therefore, in the case of a structure such as that illustrated in FIG. 17, the thickness d of the solid-state electrolyte 2 is defined as the thickness of the end portions of the solid-state electrolyte 2.

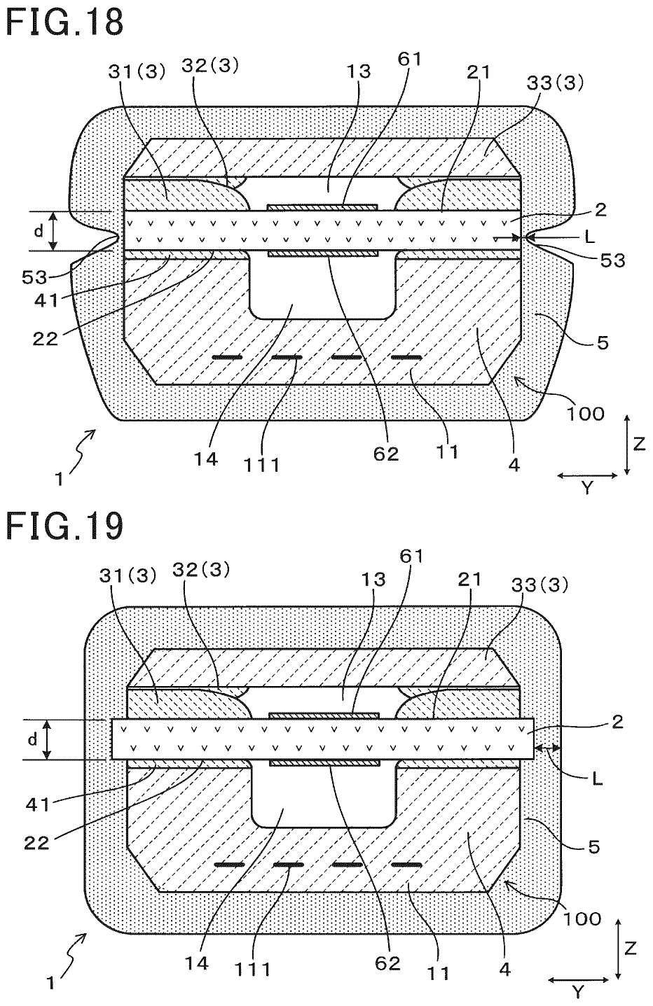

Further, as in the second modification illustrated in FIG. 18, a configuration may be adopted in which recesses 53 are provided in the protective layer 5 at a Z-directional position of the solid-state electrolyte 2. These recesses 53 extend in the X direction so as to cover at least a region where the chamber 13 is formed. This allows the thickness L of the protective layer 5 at the same Z-directional position as the solid-state electrolyte 2 to be reduced while increasing the thickness of other portions of the protective layer 5. Since inhibition of oxygen intrusion into the chamber 13 is attributable to the smallness of the thickness L of the protective layer 5 at the Z-directional position of the solid-state electrolyte 2, this thickness L is made small so as to meet d/L≥1. On the other hand, increasing the thickness of other portions of the protective layer 5 can improve functions such as trapping poisoning substances and inhibiting water-induced cracking.

Further, as in the third modification illustrated in FIG. 19, a configuration may be adopted in which the solid-state electrolyte 2 projects in the Y direction relative to other portions of the main body 100 of the gas sensor element 1. In this case as well, the thickness L of the protective layer 5 at the same Z-direction position as the solid-state electrolyte 2 can be reduced while increasing the thickness of other portions of the protective layer 5.

In the first embodiment and the like, the diffusion layer 15 is configured not to be in contact with the sensor electrode 61, but the structure is not particularly limited thereto. For example, the chamber 13 may be filled with a porous diffusion layer such that the sensor electrode 61 is in contact with the diffusion layer.

The present invention is not limited to any one of the above-described embodiments and can be applied to various embodiments without departing from the principles and spirit of the present disclosure.

While the disclosure has been described in accordance with the embodiments, it is understood that the disclosure is not limited to such embodiments or structures. The disclosure also encompasses various modifications and variations within the scope of equivalence. Furthermore, various combinations and modes, as well as other combinations and modes including only one element, more or less, thereof, are also within the scope and idea of the disclosure.

What is claimed is:

1. A gas sensor element comprising:
a solid-state electrolyte having oxygen ion conductivity;
a chamber formed on a first surface of the solid-state electrolyte, into which a gas to be measured is introduced;
a chamber forming layer that is laminated on the first surface side of the solid-state electrolyte to form the chamber;
a duct formed on a second surface of the solid-state electrolyte, into which a reference gas is introduced; and
a duct forming layer that is laminated on the second surface side of the solid-state electrolyte to form the duct, wherein
at least a distal end portion of the gas sensor element located distally from a proximal end of the chamber is covered with a porous protective layer, and
a condition of d/L≥1 is met with L denoting a thickness of the protective layer at a lamination-direction position same as that of the solid-state electrolyte and d denoting a thickness of the solid-state electrolyte.

2. The gas sensor element according to claim 1, wherein
the thickness L of the protective layer and the thickness d of the solid electrolyte meet d/L≥2.

3. The gas sensor element according to claim 1, wherein
the protective layer comprises:
a first protective layer formed to cover at least a boundary between the solid electrolyte body and the chamber forming layer; and
a second protective layer formed to cover at least a boundary between the solid electrolyte body and the duct forming layer, and wherein
a porosity of the second protective layer is higher than a porosity of the first protective layer.

4. The gas sensor element according to claim 3, wherein
the porosity of the first protective layer ranges from 20 to 40% by volume, and
the porosity of the second protective layer ranges from 40 to 70% by volume.

5. A gas sensor comprising:
the gas sensor element;
a housing that holds the gas sensor element; and
an element cover attached to a distal end side of the housing and surrounding the gas sensor element from the distal end side, the element cover having a vent hole disposed to face the chamber in the gas sensor element, wherein
the gas sensor element comprising:
a solid-state electrolyte having oxygen ion conductivity;
a chamber formed on a first surface of the solid-state electrolyte, into which a gas to be measured is introduced;
a chamber forming layer that is laminated on the first surface side of the solid-state electrolyte to form the chamber;
a duct formed on a second surface of the solid-state electrolyte, into which a reference gas is introduced; and
a duct forming layer that is laminated on the second surface side of the solid-state electrolyte to form the duct, wherein
at least a distal end portion of the gas sensor element located distally from a proximal end of the chamber is covered with a porous protective layer, and
a condition of d/L≥1 is met with L denoting a thickness of the protective layer at a lamination-direction position same as that of the solid-state electrolyte and d denoting a thickness of the solid-state electrolyte.

6. The gas sensor element according to claim 5, wherein
the thickness L of the protective layer and the thickness d of the solid electrolyte meet d/L≥2.

7. The gas sensor element according to claim 5, wherein
the protective layer comprises:
a first protective layer formed to cover at least a boundary between the solid electrolyte body and the chamber forming layer; and
a second protective layer formed to cover at least a boundary between the solid electrolyte body and the duct forming layer, and wherein
a porosity of the second protective layer is higher than a porosity of the first protective layer.

8. The gas sensor element according to claim 7, wherein
the porosity of the first protective layer ranges from 20 to 40% by volume, and
the porosity of the second protective layer ranges from 40 to 70% by volume.
